(19) United States
(12) Patent Application Publication
(10) Pub. No.: US 2024/0253129 A1
(43) Pub. Date: Aug. 1, 2024

(54) PERPENDICULAR CLAMPING INTERFACE FOR FACE SEALING

(71) Applicant: Vitesco Technologies USA, LLC, Auburn Hills, MI (US)

(72) Inventors: Mohammad Abujubbeh, Chatham (CA); Alexander Dragojlov, Chatham (CA)

(73) Assignee: Vitesco Technologies USA, LLC, Auburn Hills, MI (US)

(21) Appl. No.: 18/492,196

(22) Filed: Oct. 23, 2023

Related U.S. Application Data
(63) Continuation of application No. 63/482,694, filed on Feb. 1, 2023.

(51) Int. Cl. B23B 31/107

(52) U.S. Cl. CPC B23B 31/107

(57) ABSTRACT

A clamping mechanism used for connecting one or more conduits or hoses to a housing. The clamping mechanism uses bolt tension and a wedge interface, where the perpendicular movement of the wedge interface reduces the interface distance and creates compression in the desired direction. At least one clamping component is assembled from one axis perpendicular from the clamping to achieve desired sealing. The interface of the clamp, a tube flange, and a housing create a progressive clamping force based on several wedge-shaped features. A portion of the interface may be molded into a separate part such that there are multiple connections using a single clamping mechanism.

### CROSS-REFERENCE TO RELATED APPLICATIONS

This application claims the benefit of provisional application 63/482,694, filed Feb. 1, 2023. The disclosure of the above application is incorporated herein by reference.

### FIELD OF THE INVENTION

The invention relates generally to a clamping mechanism used for connecting one or more conduits or hoses to a housing, such that the connection between the conduit and the housing compresses a seal.

### BACKGROUND OF THE INVENTION

Electric vehicles typically have cooling systems for providing thermal management of various components. These cooling systems include various modules, valve assemblies, etc., for distributing coolant to the various components of the cooling system. The modules or valve assemblies are typically connected to one or more conduits. The connection between each conduit and the housing of the module must minimize or eliminate the potential for leaking.

Current designs incorporate the use of various connector assemblies to connect one or more conduits to the housing of the module. However, these current designs do not have an efficient or suitable solution to providing a connection between at least one conduit and a housing which provides suitable sealing, minimizing or eliminating leaks. Most current designs have a connector assembly where one or more seals are compressed as a fastener is connected and tightened. This typically results in the compressive force on the seal and the clamping force from the fastener being in the same direction (i.e., parallel to one another). Because of the orientation of the fasteners relative to other components of the connector assembly, many typical current connector assembly designs do not facilitate easy replacement of seals or other components.

Accordingly, there exists a need for connection between one or more conduits and a housing of a module, where the connection prevents leaks, and is easily serviced.

### SUMMARY OF THE INVENTION

The present invention is a clamping mechanism used for connecting one or more conduits or hoses to a housing.

In an embodiment, the clamping mechanism of the present invention uses bolt tension and a wedge interface, where the perpendicular movement of the wedge interface reduces the interface distance and creates compression in the desired direction.

At least one clamping component is assembled from one axis perpendicular from the clamping to achieve desired sealing. The interface of the clamp, tube flange, and housing create a progressive clamping force based on several wedge-shaped features.

In an embodiment, a portion of the interface is molded into a separate part such that there are multiple connections using a single clamping mechanism.

In an embodiment, the present invention is a clamping assembly, which includes a first clamping component, a first angled clamping surface integrally formed as part of the first clamping component, and a second angled clamping surface integrally formed as part of the first clamping component. The clamping assembly also includes a second clamping component, where at least one angled clamping surface is integrally formed as part of the second clamping component. The clamping assembly also includes at least one circular flange portion integrally formed with a conduit, at least one angled clamping surface integrally formed as part of the at least one circular flange portion, a housing portion, at least one semicircular flange portion integrally formed with the housing portion. and at least one angled clamping surface integrally formed as part of the at least one semicircular flange portion.

In an embodiment, the first clamping component is assembled to the second clamping component such that both the first angled clamping surface integrally formed as part of the first clamping component and the angled clamping surface integrally formed as part of the second clamping component are in contact with and apply force to the angled clamping surface integrally formed as part of the circular flange portion, and the second angled clamping surface integrally formed as part of the first clamping component is in contact with and applies force to the angled clamping surface integrally formed as part of the semicircular flange portion.

In an embodiment, the clamping assembly includes at least one mating surface integrally formed as part of the housing portion, a groove integrally formed with the mating surface integrally formed as part of the housing portion, a seal disposed in the groove, and at least one mating surface integrally formed as part of the circular flange portion of the conduit. When the first clamping component is assembled to the second clamping component, the mating surface integrally formed as part of the conduit is in contact with the mating surface integrally formed as part of the housing portion, and the seal is compressed.

In an embodiment, the clamping assembly includes at least one semicircular recess integrally formed as part of the first clamping component, the first angled clamping surface and the second angled clamping surface integrally formed as part of the first clamping component being part of the semicircular recess integrally formed as part of the first clamping component. At least one semicircular recess is integrally formed as part of the second clamping component, and the angled clamping surface integrally formed as part of the second clamping component being part of the semicircular recess integrally formed as part of the second clamping component. The semicircular recess integrally formed as part of the first clamping component and the semicircular recess integrally formed as part of the second clamping component are adjacent one another when the first clamping component is connected to the second clamping component, forming at least one clamping recess.

In an embodiment, the clamping assembly includes at least one fastener, at least one aperture integrally formed as part of the first clamping component, and at least one threaded aperture integrally formed as part of the second clamping component. The fastener is inserted into the aperture and into the threaded aperture to secure the first clamping component to the second clamping component.

In an embodiment, the clamping assembly includes at least one mating surface being part of the first clamping component, at least one mating surface integrally formed as part of the second clamping component, and at least one mating surface integrally formed as part of the housing portion. The first clamping component is assembled to the second clamping component such that the mating surface of the first clamping component contacts the mating surface formed as part of the second clamping component and the mating surface of the first housing portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a conduit connected to housing having a clamping mechanism, according to embodiments of the present invention;

FIG. 2 is a perspective view of a housing and part of a clamping mechanism, according to embodiments of the present invention;

FIG. 3 is a sectional view taken along lines 3-3 of FIG. 2;

FIG. 4 is the same sectional view as FIG. 3, with a conduit assembled to the housing, according to embodiments of the present invention;

FIG. 5 is a sectional view taken along lines 5-5 of FIG. 1;

FIG. 6A is a perspective view of a first clamping component used as part of a clamping mechanism, according to embodiments of the present invention;

FIG. 6B is a perspective view of a fastener used as part of a clamping mechanism, according to embodiments of the present invention;

FIG. 6C is a sectional view taken along lines 6C-6C of FIG. 6A; and

FIG. 6D is a perspective view of a second clamping component used as part of a clamping mechanism, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

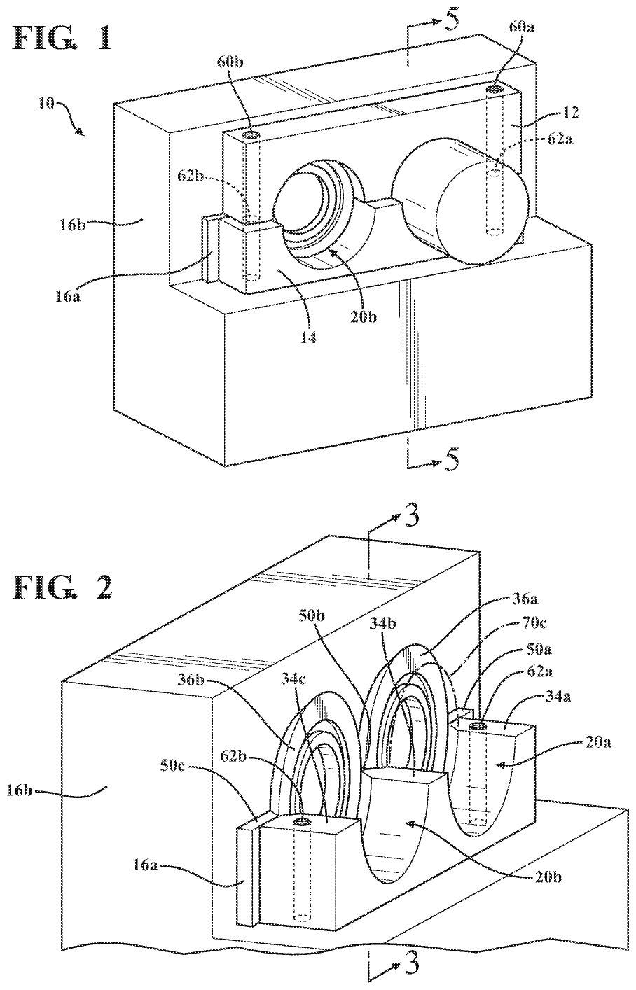

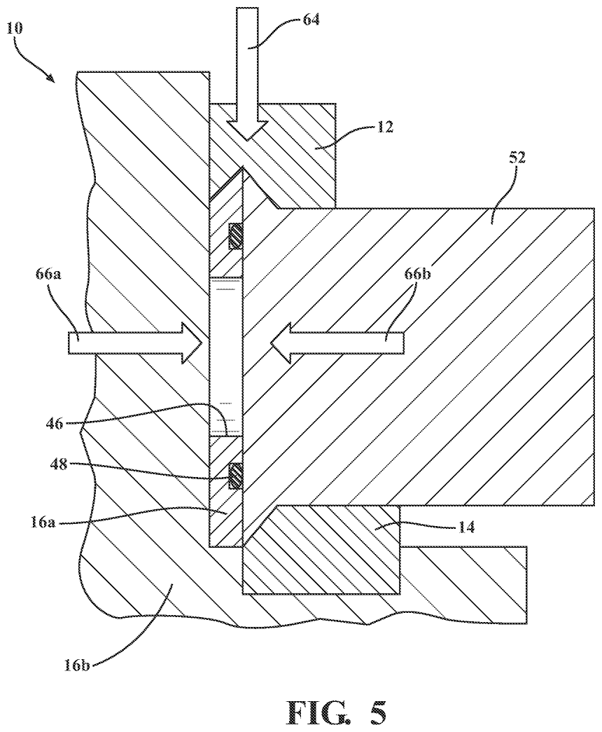

A clamping assembly according to the present invention which is used for connecting one or more conduits or hoses to a housing is shown in the Figures generally at 10. Referring to FIGS. 1 and 5, the clamping assembly 10 includes a first clamping component 12, and a second clamping component 14, where the second clamping component 14 may be integrally formed with two housing portions 16a, 16b, or the second clamping component 14 may be a separate component and connected to the housing portions 16a, 16b. In the embodiment shown, the second clamping component 14 and the housing portions 16a, 16b are integrally formed with one another.

Referring to FIGS. 1-2, 5, 6A, and 6C-6D, the first clamping component 12 includes semicircular recesses, shown generally at 18a, 18b, respectively, and the second clamping component 14 also includes two semicircular recesses, shown at 20a,20b, respectively, such that when the first clamping component 12 is attached to the second clamping component 14, two clamping recesses are formed, which are used for securing two conduits to the housing portion 16a. Although each clamping component 12,14 includes two semicircular recesses 18a, 18b,20a,20b, it is within the scope of the invention that each clamping component 12,14 may have more or less recesses to accommodate more or less conduits.

The first semicircular recess 18a,20a of each clamping component 12,14 is described, but it is within the scope of the invention that the description applies to the other recesses 18b,20b as well.

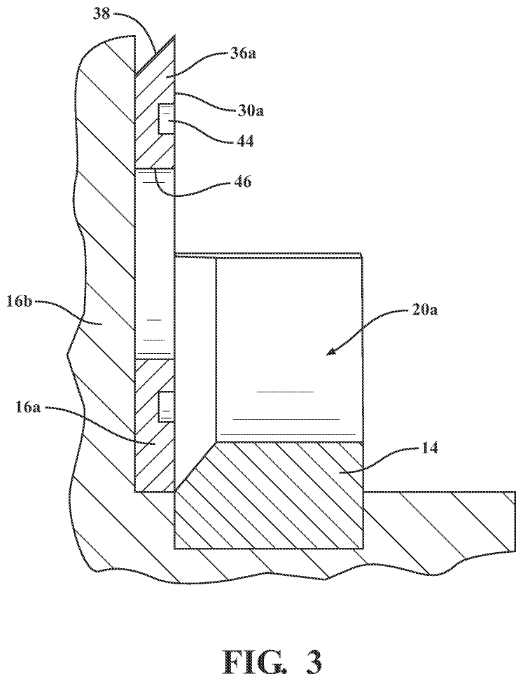

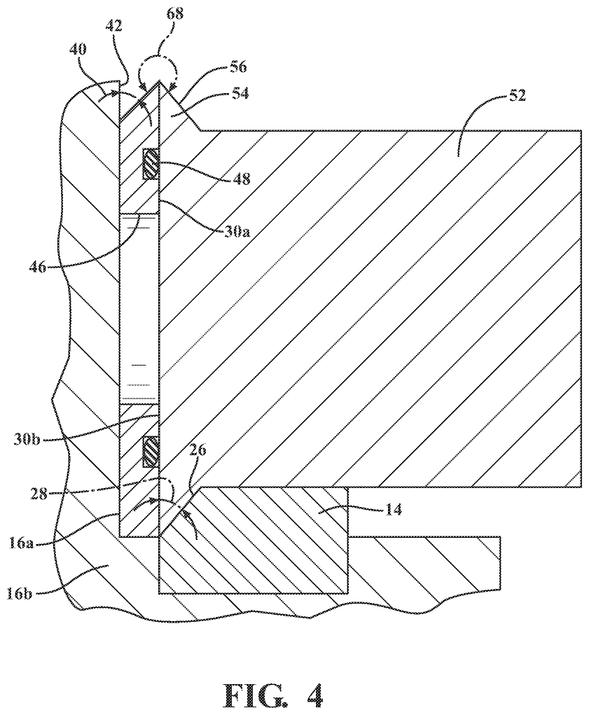

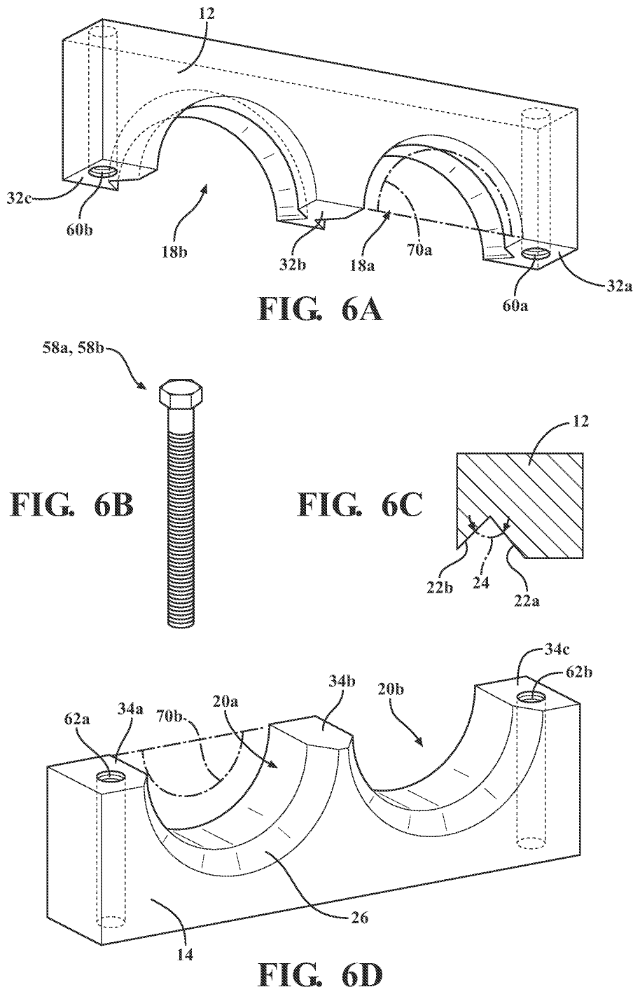

In the embodiment shown, the angle 70a of the first semicircular recess 18a of the first clamping component 12 is approximately 180° and angle 70b of the first semicircular recess 20a of the second clamping component 14 is also approximately 180°, but it is within the scope of the invention that each semicircular recess 18a,20a may be smaller or larger, depending upon the application. The first semicircular recess 18a includes two angled clamping surfaces 22a,22b. Referring to FIG. 6C, the angle 24 between the angled clamping surfaces 22a,22b of the first clamping component 12 in the embodiment shown is approximately 90°, but it is within the scope of the invention that other angles may be used. There is also an angled clamping surface 26 integrally formed as part of the first semicircular recess 20a of the second clamping component 14. As shown in FIGS. 3-4, the angled clamping surface 26 is also located at an angle 28 relative to a mating surface 30a of the first housing portion 16a.

The first clamping component 12 also includes several mating surfaces 32a, 32b, 32c, which are in contact with several corresponding mating surfaces 34a, 34b, 34c formed as part of the second clamping component 14 when the first clamping component 12 is attached to the second clamping component 14.

Referring to FIGS. 2-5, the first housing portion 16a has two semicircular flanges 36a, 36b. The first semicircular flange 36a of the first housing portion 16a is described, but it is within the scope of the invention that the description applies to the other semicircular flange 36b as well. In the embodiment shown, the angle 70c of the first semicircular flange 36a is approximately 180°, but it is within the scope of the invention that angle 70c of the first semicircular flange 36a may be smaller or larger, depending upon the application. The first semicircular flange 36a includes an angled clamping surface 38, which is located at an angle 40 relative to an exterior surface 42 of the second housing portion 16b.

Integrally formed as part of the first housing portion 16a is a groove 44, and an aperture 46. Disposed in the groove 44 is a seal 48, which in this embodiment is an O-ring. The first housing portion 16a also includes mating surfaces 50a,50b,50c which are in contact with the mating surfaces 32a, 32b,32c of the first clamping component 12 when the first clamping component 12 is attached to the second clamping component 14.

As mentioned above, the clamping recesses are used to connect one or more conduits to the housing portion 16a. Referring to FIGS. 4-5, a conduit 52 is shown. The conduit 52 has a circular flange portion 54 which circumscribes the conduit 52. The circular flange portion 54 has an angled clamping surface 56. When the conduit 52 is assembled to the first housing portion 16a, half of the circular flange portion 54 is in contact with the first clamping component 12, and the other half of the circular flange portion 54 is in contact with the second clamping component 14. More specifically, half of the angled clamping surface 56 is in contact with the angled clamping surface 22a of the first clamping component 12, and the other half of the angled clamping surface 56 is in contact with the angled clamping surface 26 of the second clamping component 14. Also, when assembled, the conduit 52 includes a mating surface 30b which is in contact with the mating surface 30a of the first housing portion 16a.

The clamping assembly 10 also includes at least one fastener, and in this embodiment, there are two fasteners 58a,58b. The first clamping component 12 includes two apertures 60a, 60b which are non-threaded, and the second clamping component 14 include two apertures 62a,62b which are threaded.

During assembly, the conduit 52 is positioned as shown in FIG. 4, where a portion of the clamping surface 56 is placed in contact with the angled clamping surface 26 of the second clamping component 14. However, when the conduit 52 is initially placed in this position, the mating surface 30b of the conduit 52 is not in contact with the mating surface 30a of the first housing portion 16a. The diameter of the O-ring 48 is such that at least a portion of the O-ring 48 protrudes out of the groove 44 when the O-ring is not compressed. Therefore, the mating surface 30b of the conduit 52 is in contact with the mating surface 30a of the first housing portion 16a.

After the conduit 52 is placed in the position shown in FIG. 4, the first clamping component 12 is attached to the first housing portion 16a and the second clamping component 14. To connect the first clamping component 12 to the second clamping component 14, the first clamping component 12 is positioned such that part of the first angled clamping surface 22a of the first clamping component 12 is in contact with at least a portion of the angled clamping surface 56 of the circular flange portion 54, and part of the other angled clamping surface 22b is in contact with a portion of the angled clamping surface 38 of the housing portion 16a. One of the fasteners 58a is then inserted into the aperture 60a integrally formed as part of the first clamping component 12 and into the threaded aperture 62a integrally formed as part of the second clamping component 14b. Similarly, the other of the fasteners 58b is then inserted into the aperture 60b integrally formed as part of the first clamping component 12 and into the threaded aperture 62b integrally formed as part of the second clamping component 14. As the fasteners 58a, 58b are tightened, the first clamping component 12 moves in the direction of the arrow 64, and force, also in the direction of the arrow 64, is applied to the angled clamping surface 38 and the angled clamping surface 56. Because of the shape of the angled clamping surfaces 22a,22b,26,38,56, the movement of the first clamping component 12 in the direction of the arrow 64 forces the conduit 52 to move towards the housing portion 16a, as indicated by the arrows 66a, 66b.

As the conduit 52 moves toward the housing portion 16a, a compressive force, also in the direction indicated by the arrows 66a,66b, is applied to the O-ring 48, and the mating surface 30a of the first housing portion 16a contacts the mating surface 30b of the conduit 52. The clamping force, indicated by the arrow 64, is parallel to the compressive force, indicated by the arrows 66a, 66b, applied to the O-ring 48.

The fasteners 58a,58b are tightened until the mating surface 32a of the first clamping component 12 contacts the mating surface 34a formed as part of the second clamping component 14 and the mating surface 50a of the first housing portion 16a, the mating surface 32b of the first clamping component 12 contacts the mating surface 34b formed as part of the second clamping component 14 and the mating surface 50b of the first housing portion 16a, and the mating surface 32c of the first clamping component 12 contacts the mating surface 34c formed as part of the second clamping component 14 and the mating surface 50c of the first housing portion 16a.

Once the fasteners 58a, 58b are tightened, the mating surface 30a of the first housing portion 16a is in contact with the mating surface 30b of the conduit 52, and the O-ring 48 is compressed. Also, when the mating surface 30a of the first housing portion 16a is in contact with the mating surface 30b of the conduit 52, the angle 68 between the angled clamping surface 38 of the first semicircular flange 36a and the angled clamping surface 56 of the circular flange portion 54 is approximately 270°. The angle 68 between the angled clamping surface 38 of the first semicircular flange 36a and the angled clamping surface 56 of the circular flange portion 54 and the angle 24 between the angled clamping surfaces 22a,22b of the first clamping component 12 are complementary to one another. Furthermore, when the fasteners 58a,58b are tightened, the angled clamping surface 26 integrally formed as part of the second clamping component 14 is complementary to the shape of the angled clamping surface 56 of the circular flange portion 54.

Once the fasteners 58a,58b are tightened, the conduit 52 is secured to the housing portion 16a. The fasteners 58a,58b being oriented perpendicular to the compressive force (indicated by the arrows 66a,66b) applied to the O-ring 48 allows for easier access to the fasteners 58a,58b when one or more tools are used to insert the fasteners 58a,58b into the apertures 60a,60b and the threaded apertures 62a,62b.

Although the connection of the one conduit 52 to the housing 16a is described, it is within the scope of the invention that the clamping assembly 10 may be used to connect several conduits to the housing 16a. In other embodiments, the first clamping component 12 and the second component 14 may have additional semi-circular recesses to accommodate the connection of additional conduits to the housing 16a.

As mentioned above, the first clamping component 12 is attached to the second clamping component 14 using the fasteners 58a,58b. However, it is within the scope of the invention that other types of fastening methods, such as, but not limited to, welding or the like, may be used.

It is also within the scope of the invention that in alternate embodiments, the angled clamping surface 38 may not be necessary, and the housing 16a may have a top surface which is flat, similar to the bottom surface of the housing 16a.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A apparatus, comprising:
a clamping assembly, including:
a first clamping component;
at least one angled clamping surface integrally formed as part of the first clamping component;
a second clamping component;
at least one angled clamping surface integrally formed as part of the second clamping component;
at least one circular flange portion integrally formed with a conduit; and
a housing portion;
wherein the first clamping component is assembled to the second clamping component such that both the at least one angled clamping surface integrally formed as part of the first clamping component and the at least one angled clamping surface integrally formed as part of the second clamping component are in contact with and apply force to the at least one circular flange portion integrally formed with the conduit, such that the at least one circular flange portion is in contact with and applies force to the housing portion.

2. The apparatus of claim 1, further comprising:
at least one semicircular flange portion integrally formed with the housing portion;
at least one angled clamping surface integrally formed as part of the at least one semicircular flange portion; and
a second angled clamping surface integrally formed as part of the first clamping component;
wherein the first clamping component is assembled to the second clamping component such that the second angled clamping surface integrally formed as part of the first clamping component is in contact with and applies force to the at least one angled clamping surface integrally formed as part of the at least one semicircular flange portion.

3. The apparatus of claim 1, further comprising:
at least one mating surface integrally formed as part of the housing portion; and
at least one mating surface integrally formed as part of the conduit;
a groove integrally formed with at least one mating surface integrally formed as part of the housing portion; and
a seal disposed in the groove;
wherein when the first clamping component is assembled to the second clamping component, the at least one mating surface integrally formed as part of the conduit is in contact with at least one mating surface integrally formed as part of the housing portion, and the seal is compressed.

4. The apparatus of claim 1, further comprising:
at least one angled clamping surface integrally formed as part of the at least one circular flange portion of the conduit;
wherein the at least one angled clamping surface integrally formed as part of the first clamping component and the at least one angled clamping surface integrally formed as part of the second clamping component are in contact with and apply force to the at least one angled clamping surface integrally formed with the at least one circular flange portion of the conduit.

5. The apparatus of claim 1, further comprising:
at least one semicircular recess integrally formed as part of the first clamping component, the at least one angled clamping surface integrally formed as part of the first clamping component being part of the at least one semicircular recess integrally formed as part of the first clamping component; and
at least one semicircular recess integrally formed as part of the second clamping component, the at least one angled clamping surface integrally formed as part of the second clamping component being part of the at least one semicircular recess integrally formed as part of the second clamping component;
wherein at least one clamping recess is formed when the first clamping component is connected to the second clamping component.

6. The apparatus of claim 1, further comprising:
at least one fastener;
at least one aperture integrally formed as part of the first clamping component; and
at least one threaded aperture integrally formed as part of the second clamping component;
wherein the at least one fastener is inserted into the at least one aperture and into the at least one threaded aperture to secure the first clamping component to the second clamping component.

7. The apparatus of claim 1, further comprising:
at least one mating surface being part of the first clamping component; and
at least one mating surface integrally formed as part of the second clamping component;
at least one mating surface integrally formed as part of the housing portion;
wherein when the first clamping component is assembled to the second clamping component, the at least one mating surface of the first clamping component contacts the at least one mating surface formed as part of the second clamping component and the at least one mating surface of the first housing portion.

8. A clamping assembly, comprising:
a first clamping component;
a first angled clamping surface integrally formed as part of the first clamping component;
a second angled clamping surface integrally formed as part of the first clamping component;
a second clamping component;
at least one angled clamping surface integrally formed as part of the second clamping component;
at least one circular flange portion integrally formed with a conduit;
at least one angled clamping surface integrally formed as part of the at least one circular flange portion;
a housing portion;
at least one semicircular flange portion integrally formed with the housing portion; and
at least one angled clamping surface integrally formed as part of the at least one semicircular flange portion;
wherein the first clamping component is assembled to the second clamping component such that both the first angled clamping surface integrally formed as part of the first clamping component and the at least one angled clamping surface integrally formed as part of the second clamping component are in contact with and apply force to the at least one angled clamping surface integrally formed as part of at least one circular flange portion, and the second angled clamping surface integrally formed as part of the first clamping component is in contact with and applies force to the at least one angled clamping surface integrally formed as part of the at least one semicircular flange portion.

9. The clamping assembly of claim 8, further comprising:
at least one mating surface integrally formed as part of the housing portion;
a groove integrally formed with at least one mating surface integrally formed as part of the housing portion;
a seal disposed in the groove; and
at least one mating surface integrally formed as part of the at least one circular flange portion of the conduit;
wherein when the first clamping component is assembled to the second clamping component, the at least one mating surface integrally formed as part of the conduit is in contact with at least one mating surface integrally formed as part of the housing portion, and the seal is compressed.

10. The clamping assembly of claim 8, further comprising:
at least one semicircular recess integrally formed as part of the first clamping component, the first angled clamping surface and the second angled clamping surface integrally formed as part of the first clamping component being part of the at least one semicircular recess integrally formed as part of the first clamping component; and
at least one semicircular recess integrally formed as part of the second clamping component, the at least one angled clamping surface integrally formed as part of the second clamping component being part of the at least one semicircular recess integrally formed as part of the second clamping component;
wherein at least one semicircular recess integrally formed as part of the first clamping component and the at least one semicircular recess integrally formed as part of the second clamping component are adjacent one another when the first clamping component is connected to the second clamping component, forming at least one clamping recess.

11. The clamping assembly of claim 1, further comprising:
at least one fastener;
at least one aperture integrally formed as part of the first clamping component; and
at least one threaded aperture integrally formed as part of the second clamping component;
wherein the at least one fastener is inserted into the at least one aperture and into the at least one threaded aperture to secure the first clamping component to the second clamping component.

12. The clamping assembly of claim 1, further comprising:
at least one mating surface being part of the first clamping component; and
at least one mating surface integrally formed as part of the second clamping component;
at least one mating surface integrally formed as part of the housing portion;
wherein when the first clamping component is assembled to the second clamping component, the at least one mating surface of the first clamping component contacts the at least one mating surface formed as part of the second clamping component and the at least one mating surface of the first housing portion.
